(19) United States
(12) Patent Application Publication
(10) Pub. No.: US 2024/0354165 A1
(43) Pub. Date: Oct. 24, 2024

(54) GRID COMPUTING MANAGEMENT DEVICE AND MANAGEMENT METHOD

(71) Applicant: MAZDA MOTOR CORPORATION, Hiroshima (JP)

(72) Inventors: Seiichi ITO, Higashihiroshima-shi, Hiroshima (JP); Masashi OKAMURA, Hiroshima-shi, Hiroshima (JP); Takashi MAEDA, Hiroshima-shi, Hiroshima (JP); Yuji FURUKAWA, Hiroshima-shi, Hiroshima (JP)

(73) Assignee: MAZDA MOTOR CORPORATION, Hiroshima (JP)

(21) Appl. No.: 18/684,857

(22) PCT Filed: Aug. 2, 2022
(86) PCT No.: PCT/JP2022/029660

§ 371 Date: Feb. 20, 2024

(30) Foreign Application Priority Data
Aug. 31, 2021 (JP) 2021-140664

(51) Int. Cl. G06F 9/50

(52) U.S. Cl. CPC G06F 9/505

(57) ABSTRACT

Grid computing processing is managed considering rate of amount of renewable energy-derived electric power in amount of electric power used for computation by computing device of vehicles, thereby contributing to utilization of renewable energy. Management server manages grid computing processing of causing computing devices mounted on a plurality of vehicles to process job data provided from client server. Controller of the management server acquires overall renewable energy rate information indicative of the rate of the amount of renewable energy-derived electric power in the amount of electric power consumption used for computation of the job data by all computing devices assigned to the job data, based on the amount of computations for a part of the job data to be processed by each of the computing devices and renewable energy rate information of each of the computing devices, and transmits the overall renewable energy rate information to the client server.

### TECHNICAL FIELD

The technique disclosed here relates to management of grid computing.

### BACKGROUND ART

The following Patent Document 1 discloses a system comprising a plurality of communication devices, and a management server for managing grid computing. The management server comprises a signal receiving part, a state determination part, and a response transmitting part. The signal receiving part receives, from a communication device, a signal indicating that the communication device is ready to participate in grid computing. The state determination part determines the state of insufficiency of processing capacity of each of a plurality of processing units, based on a usage status of a computational resource in each of the plurality of processing units. When the processing capacity of at least one of the plurality of processing units is insufficient, the response transmitting part transmits an instruction to the above communication device to participate in grid computing based on the above signal. This configuration makes it possible to effectively use the computational resources of the plurality of communication devices.

### CITATION LIST

### Patent Document

Patent Document 1: JP-A 2020-160661

### SUMMARY OF INVENTION

### Technical Problem

However, the conventional technique as described in the Patent Document 1 does not take into consideration the rate of renewable energy in the amount of electric power consumption used for computation by each communication device of vehicles participating in grid computing.

The present invention has been made to solve the above problem, and an object thereof is to provide a management device and a management method which are capable of performing management of grid computing processing in consideration of the rate of the amount of renewable energy-derived electric power in the amount of electric power used for computation by each computing device of vehicles, thereby contributing to utilization renewable energy.

### Solution to Technical Problem

In order to achieve the above object, the present invention provides a management device for managing grid computing processing of causing computing devices mounted respectively on a plurality of vehicles to process job data provided from a client server, the management device comprising a storage, and a controller, wherein: the storage is configured to store renewable energy rate information indicative of a rate of an amount of renewable energy-derived electric power in an amount of electric power fed to each of the computing devices; and the controller is configured to perform: job acceptance processing of accepting the job data from the client server; job assignment processing of selecting one or more of the computing devices, and assigning the selected one or more computing devices to the job data; the grid computing processing of distributing the job data to respective ones of the one or more computing devices assigned to the job data, receiving computational result data of the distributed job data from each of the one or more computing devices, and transmitting the received computational result data to the client server; and overall renewable energy rate provision processing of acquiring overall renewable energy rate information indicative of a rate of an amount of renewable energy-derived electric power in an amount of electric power consumption used for computation of the job data by all the one or more computing devices assigned to the job data, based on a computational amount of the distributed job data to be processed by each of the one or more computing devices, and the renewable energy rate information of said each of the one or more computing devices, and transmitting the overall renewable energy rate information to the client server.

In the present invention having the above feature, the management device for managing the grid computing processing transmits, to the client server, the overall renewable energy rate information indicative of the rate of the amount of renewable energy-derived electric power in the amount of electric power consumption used for computation of the job data by all the one or more computing devices assigned to the job data. This makes it possible to inform an operator of the client server which provided the job data of the rate of renewable energy in electric power used during the grid computing processing, thereby supporting the utilization of renewable energy by the operator of the client server which requested for the grid computing processing.

Preferably, in the present invention, the storage is configured to store a possible computational amount by which each of the computing devices is computable in the grid computing processing, and the controller is configured to use, in the overall renewable energy rate provision processing, as the overall renewable energy rate information, a weighted average obtained by weighting a rate of an amount of renewable energy-derived electric power in an amount of electric power fed to each of the one or more computing devices assigned to the job data by the possible computational amount of said each of the one or more computing devices.

According to the above feature, the weighted average obtained by weighting the renewable energy rate in each of the one or more computing devices assigned to the job data by the possible computational amount of said each of the one or more computing devices is used as the overall renewable energy rate information. Thus, it becomes possible to inform the operator of the client server of the renewable energy rate obtained by taking into consideration the computational amount required for computation of the job data, and the possible computational amount in each of the one or more computing devices, thereby supporting the operator of the client server to adequately figure out a renewable energy usage status in the grid computing processing.

According to another aspect, in order to achieve the above object, the present invention provides a management method for managing, by a computer, grid computing processing of causing computing devices mounted respectively on a plurality of vehicles to process job data provided from a client server, the management method comprising: a storage step of storing renewable energy rate information indicative of a rate of an amount of renewable energy-derived electric power in an amount of electric power fed to each of the computing devices; a job acceptance step of accepting the job data from the client server; a job assignment step of selecting one or more of the computing devices, and assigning the selected one or more computing devices to the job data; a grid computing step of distributing the job data to respective ones of the one or more computing devices assigned to the job data, receiving computational result data of the distributed job data from each of the one or more computing devices, and transmitting the received computational result data to the client server; and an overall renewable energy rate provision step of acquiring overall renewable energy rate information indicative of a rate of an amount of renewable energy-derived electric power in an amount of electric power consumption used for computation of the job data by all the one or more computing devices assigned to the job data, based on a computational amount of the distributed job data to be processed by each of the one or more computing devices, and the renewable energy rate information of said each of the one or more computing devices, and transmitting the overall renewable energy rate information to the client server.

In the present invention having the above feature, it is also possible to transmit, to the client server, the overall renewable energy rate information indicative of the rate of the amount of renewable energy-derived electric power in the amount of electric power consumption used for computation of the job data by all the one or more computing devices assigned to the job data. This makes it possible to inform an operator of the client server which has provided the job data of the rate of renewable energy in electric power used during the grid computing processing, thereby supporting the utilization of renewable energy by the operator of the client server which has requested for the grid computing processing.

### Effect of Invention

The management device and the management method according to the present invention make it possible to perform management of grid computing professing in consideration of the rate of renewable energy-derived electric power in the amount of electric power used during computation by each computing device of vehicles.

### BRIEF DESCRIPTION OF DRAWINGS

FIG. 1 is a schematic diagram exemplifying the configuration of a system according to an embodiment of the present invention.

FIG. 2 is a conceptual diagram for explaining grid computing.

FIG. 3 is a block diagram exemplifying the configuration of a vehicle.

FIG. 4 is a block diagram exemplifying the configuration of a user terminal.

FIG. 5 is a block diagram exemplifying the configuration of a client server.

FIG. 6 is a block diagram exemplifying the configuration of a facility server.

FIG. 7 is a block diagram exemplifying the configuration of a management server.

FIG. 8 is a flowchart exemplifying job acceptance processing.

FIG. 9 is a schematic diagram exemplifying a screen image of a job acceptance screen.

FIG. 10 is a flowchart exemplifying computational resource evaluation processing.

FIG. 11 is a flowchart exemplifying job assignment processing.

FIG. 12 is a flowchart exemplifying grid computing processing.

FIG. 13 is a schematic diagram exemplifying a screen image of a confirmation screen.

FIG. 14 is a flowchart exemplifying renewable energy-based feed request processing.

### DESCRIPTION OF EMBODIMENTS

With reference to the drawings, an embodiment of the present invention will now be described in detail. It should be noted that the same or equivalent elements or parts in the figures are assigned with the same reference sign, and description thereof will not be repeated.

### System

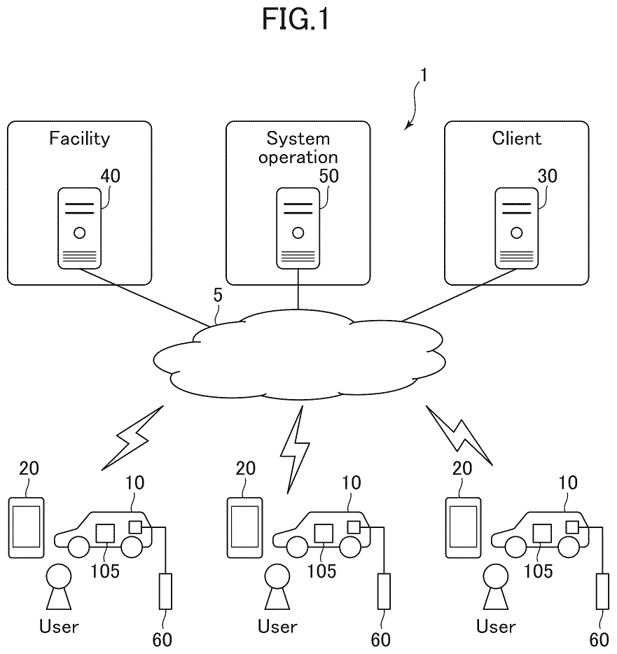

FIG. 1 exemplifies the configuration of a system 2 according to an embodiment of the present invention. This system 1 comprises a plurality of vehicles 10, a plurality of user terminals 20, a client server 30, a facility server 40, and a management server 50. These components are mutually communicable via a communication network 5. A plurality of computing devices 105 are mounted on the plurality of vehicles, respectively. Each of the vehicles 10 is capable of receiving power feeding from a charging facility 60 to charge a battery mounted on the vehicle 10, and feeding electric power to the computing device 105 mounted thereon. It should be noted that the system 1 may be provided with a plurality of client server 30. It should also be noted that the system 1 may be provided with a plurality of facility server 40,

### Grid Computing

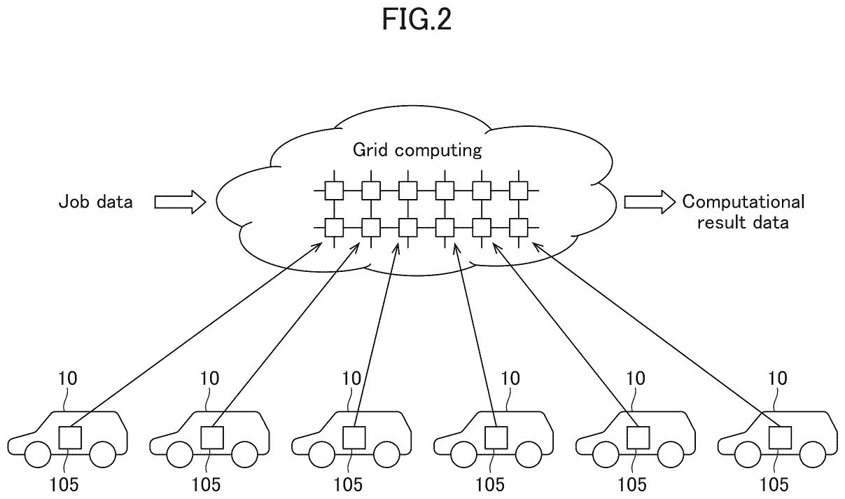

As shown in FIG. 2, in the system 1 according to this embodiment, grid computing is constructed by the plurality of computing devices 105, to perform grid computing processing for causing usable computing devices 105 among the plurality of computing devices 105 to process job data.

When the computational power of the computing device 105 becomes necessary in the vehicle 10, the computing device 105 enters an operating state to use the computational power of the computing device 105. For example, when the vehicle 10 is traveling, the computational power of the computing device 105 becomes necessary for travel control of the vehicle 10, and thus the computing device 105 enters an operating state.

On the other hand, when the computational power of the computing device 105 becomes unnecessary in the vehicle 10, the computing device 105 enters a non-operating state, and thus the computational power of the computing device 105 becomes unused. For example, when the vehicle 10 is stopped and powered off, the computational power of the computing device 105 becomes unnecessary, and the computing device 105 enters a non-operating state.

Here, when the computational power of the computing device 105 is unnecessary in the vehicle 10, the computational power of the computing device 105 can be effectively used by providing the computational power of the computing device 105 to the grid computing processing.

### Vehicle

The vehicle 10 is owned by a user. The user drives the vehicle 10. In this embodiment, the vehicle 10 is a four-wheel automobile.

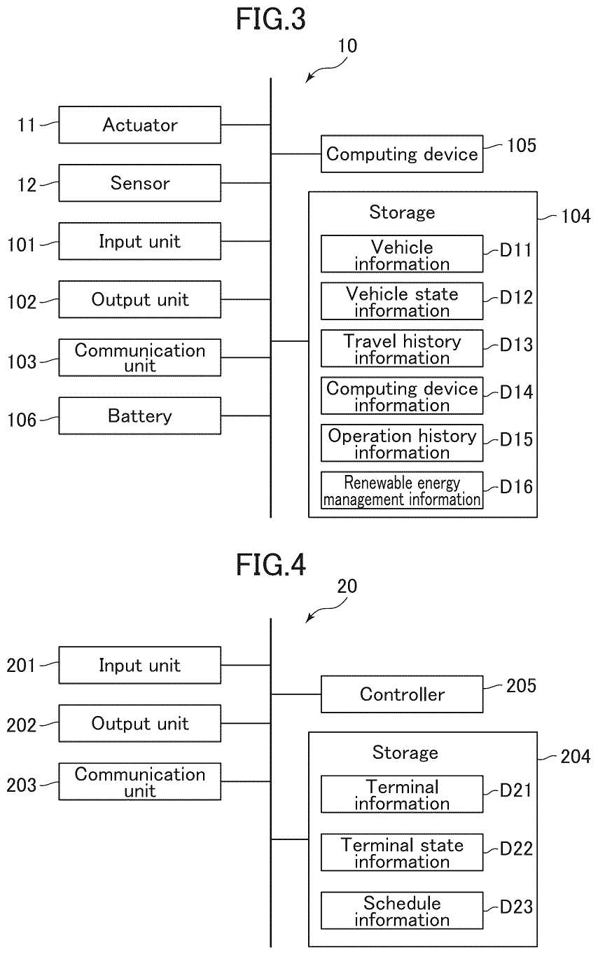

As shown in FIG. 3, the vehicle 10 comprises an actuator 11, a sensor 12, an input unit 101, an output unit 102, a communication unit 103, a storage 104, and the computing device 105. Further, a battery 106 is mounted on the vehicle 10. The battery 106 is charged by electric power fed from the charging facility 60. Electric power stored in the battery 106 is fed to an in-vehicle device such as the computing device 105. Examples of such a vehicle 10 include an electric automobile, and a plug-in hybrid automobile.

The actuator 11 includes a drive-train actuator, a steering system actuator, and a braking system actuator.

Examples of the drive-train actuator include an engine, a transmission, and a motor. Examples of the braking systems actuator include a braking device. Examples of the steering system actuator include a steering wheel.

The sensor 12 acquires various information used for control of the vehicle 10. Examples of the sensor 12 include a vehicle exterior camera for imaging the outside of the vehicle, an vehicle interior camera for imaging the inside of the vehicle, a radar for detecting objects outside the vehicle, a vehicle speed sensor, an acceleration sensor, a yaw rate sensor, an accelerator position sensor, a steering sensor, and a brake hydraulic pressure sensor.

The input unit 101 inputs information or data. Examples of the input unit 101 include: a manual operation part for, when operated, inputting information corresponding to the operation; a camera for inputting an image indicative of information; and a microphone for inputting voice indicative of information. Examples of the manual operation part include a manual operation button or a touch sensor of a car navigation device. The information or data input to the input unit 101 are sent to the computing device 105.

The output unit 102 outputs information or data. Examples of the output unit 102 include a display part for outputting an image indicative of information, and a speaker for outputting audio indicative of information. Examples of the display part include a display of a car navigation device. Examples of the speaker include a speaker of a car navigation device.

The communication unit 103 transmits and receives information or data. The information or data received by the communication unit 103 are sent to the computing device 105.

The storage 104 stores information or data.

The computing device 105 controls each section of the vehicle 10. In this embodiment, the computing device 105 controls the actuator 11 according to various information obtained by the sensor 12.

The computing device 105 comprises a processor, and a memory. Examples of the processor include a central processing unit (CPU), and a graphics processing unit (GPU). The memory stores a program for operating the processor, information or data indicative of processing results of the processor, etc.

It should be noted that the number of processors to be mounted on the computing device 105 may be one or may be two or more. A processor to be mounted on the computing device 105 may be only one of a CPU and a GPU, or may be both a CPU and a GPU. In this embodiment, the computing device 105 comprises both a CPU and a GPU. For example, the computing device 105 is composed of one or more electronic control units (ECUs).

In this embodiment, the storage 104 stores vehicle information D11, vehicle state information D12, travel history information D13, computing device information D14, operation history information D15, and renewable energy management information D16.

### Vehicle Information

The vehicle information D11 is information about the vehicle 10. For example, the vehicle information D11 includes a vehicle ID set for the vehicle 10, and vehicle performance information indicative of performance of the vehicle. The vehicle ID is one example of vehicle identification information which identifies the vehicle 10. A user ID is one example of user identification information which identifies the user.

### Vehicle State Information

The vehicle state information D12 indicates the state of the vehicle 10. Examples of the vehicle state information D12 include vehicle location information, vehicle communication information, vehicle power supply information, battery remaining amount information, and vehicle charging information. The vehicle location information indicates the location (latitude and longitude) of the vehicle 10. For example, the vehicle location information can be obtained by a global positioning system (GPS). The vehicle communication information indicates a communication state of the vehicle 10. The vehicle power supply information indicates the state of a power supply of the vehicle 10. For example, the vehicle power supply information indicates on/off of an ignition power supply, on/off of an accessory power supply, etc. The battery remaining amount information indicates a remaining amount of the battery 106 mounted on the vehicle 10. The vehicle charging information indicates whether or not the vehicle 10 is charging in the charging facility.

### Travel History Information

The travel history information D13 is information indicative of a travel history of the vehicle 10. For example, the travel history information D13 indicates the location of the vehicle 10 and time in association with each other.

### Computing Device Information

The computing device information D14 is information about the computing device 105. Examples of the computing device information D14 include: a computing device ID set for the computing device 105; a vehicle ID set for the vehicle 10 on which the computing device 105 is mounted; and computing device performance information indicative of performance of the computing device 105. The computing device ID is one example of computing device identification information which identifies the computing device 105. The performance of the computing device 105 to be indicated by the computing device performance information includes a computational power indicative of the computational power (specifically, maximum computational power) of the computing device 105, and the ratio between the CPU and the GPU in the computing device 105. The computational power of the computing device 105 means the amount of data which can be computed per unit time by the computing device 105.

### Operation History Information

The operation history information D15 is information indicative of an operation history of the computing device 105. For example, the operation history information D15 indicates a usage rate of the computational power of the computing device 105 and time in association with each other.

### Renewal Energy Management Information

The renewal energy management information D16 is information indicative of the rate of the amount of electric power derived from renewable energy (hereinafter referred to as “renewable energy-derived electric power”) in the amount of electric power stored in the battery 106. For example, when conducting charging of the battery 106 in the charging facility 60, the communication unit 103 receives, from the charging facility 60, information indicating whether or not electric power supplied from the charging facility 60 is derived from renewable energy. Just after completion of the charging by the charging facility 60, the computing device 105 calculates the renewable energy rate in the battery 106 after the end of the charging, based on the information received from the charging facility 60 (i.e. information about whether or not the charged electric power is derived from renewable energy), the amount of electric power charged from the charging facility 60 into the battery 106, and the amount of electric power and the renewal energy rate in the battery 106 before the start of the charging. For example, the amount of electric power and the renewable energy rate in the battery 106 before the start of the charging are represented as P₀ and R₀, respectively, and the amount of electric power charged from the charging facility 60 into the battery 106 is represented as P_{C}. When the charged electric power is derived from renewable energy, the renewable energy rate R in the battery 106 after the end of the charging can be calculated from the following formula: R=(P₀×R₀+P_{C})/(P₀+P_{C}). On the other hand, when the charged power is not derived from renewable energy, the renewable energy rate R in the battery 106 after the end of the charging can be calculated from the following formula: R=(P₀×R₀)/(P₀+P_{C}).The computing device 105 updates the renewable energy management information D16 by the calculated renewable energy rate.

### User Terminal

The user terminal 20 is owned by the user. The user operates the user terminal 20 to use various functions. The user can also carry the user terminal 20. Examples of the user terminals 20 include a smartphone, a tablet, and a notebook personal computer.

As shown in FIG. 4, the user terminal 20 includes an input unit 201, an output unit 202, a communication unit 203, a storage 204, and a controller 205.

The input unit 201 inputs information or data. Examples of the input unit 201 include: a manual operation part for, when operated, inputting information corresponding to the operation; a camera for inputting an image indicative of information; and a microphone for inputting voice indicative of information. Examples of the manual operation part include a manual operation button, and a touch sensor. The information input to the input unit 101 is sent to the computing device 105.

The output unit 202 outputs information or data. Examples of the output unit 202 include a display part which outputs an image indicative of information, and a speaker which outputs audio indicative of information.

The communication unit 203 transmits and receives information or data. The information or data received by the communication unit 203 are sent to the controller 205.

The storage 204 stores information or data.

The controller 205 controls each section of the user terminal 20. The controller 205 comprises a processor, and a memory. The memory stores a program for operating the processor, information or data indicative of processing results of the processor, etc.

In this embodiment, the storage 204 stores terminal information D21, terminal state information D22, and schedule information D23.

### Terminal Information

The terminal information D21 is information about the user terminal 20. Examples of the terminal information D21 include a user terminal ID set for the user terminal 20, and user terminal performance information indicative of performance of the user terminal 20. The user terminal ID is one example of user terminal identification information which identifies the user terminal 20.

### Terminal State Information

The terminal state information D22 is information indicative of the state of the user terminal 20. The terminal state information D22 includes user terminal location information indicative of the location of the user terminal 20, and user terminal communication state information indicative of the communication state of the user terminal 20.

### Schedule Information

The schedule information D23 indicates an action history and action schedule of the user owning the user terminal 20. For example, the schedule information D23 indicates the location of the user and a stay period (or scheduled stay period) in association with each other. The schedule information D23 can be acquired by a scheduling function incorporated in the user terminal 20. Specifically, the user can input his/her action history and action schedule to the user terminal 20 using the scheduling function so as to provide the schedule information D23 indicative of the action history and action schedule of the user.

### Client Server

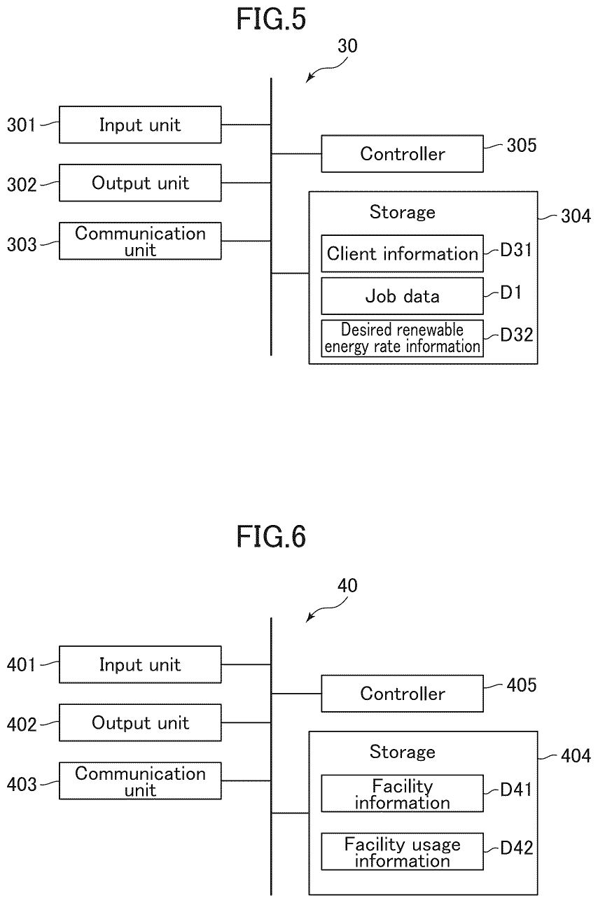

The client server 30 is owned by a client. The client requests for computation of job data. Examples of the client include a company, a research institution, and an educational institution. As shown in FIG. 5, the client server 30 comprises an input unit 301, an output unit 302, a communication unit 303, a storage 304, and a controller 305.

The input unit 301 inputs information or data. Examples of the input unit 301 include: a manual operation part for, when operated, inputting information corresponding to the operation; a camera for inputting an image indicative of information; and a microphone for inputting voice indicative of information. Examples of the manual operation part include a manual operation button, a touch sensor, a keyboard, and a mouse. The information or data input to the input unit 301 are sent to the controller 305.

The output unit 302 outputs information or data. Examples of the output unit 302 include a display part which outputs an image indicative of information, and a speaker which outputs audio indicative of information.

The communication unit 303 transmits and receives information or data. The information or data received by the communication unit 303 are sent to the controller 305. The storage 304 stores information or data.

The controller 305 controls each section of the client server 30. The controller 305 comprises a processor, and a memory. The memory stores a program for operating the processor, and information or data indicative of processing results of the processor.

In this embodiment, the storage 304 stores client information D31, job data D1, and desired renewable energy rate information D32.

### Client Information

The client information D31 is information about the client. The client information D31 includes a client ID set for the client, a client server ID set for the client server 30 owned by the client, and the person-in-charge name, address and telephone number of the client. The client ID is one example of client identification information which identifies the client. The client server ID is one example of client server identification information which identifies the client server 30.

### Job Data

Job data D1 is data corresponding to a job and is data to be processed for implementation of the job.

The job data D1 can be classified by computation types. Examples of the computation types include a CPU-based computation type, and a GPU-based computation type. In the CPU-based computation-type job data D1, complicated computation having many conditional branches, such as simulation computations, tends to be required. In the GPU-based computation-type job data D1, a vast amount of simple computations, such as image processing and machine learning, tend to be required.

The job data D1 can also be classified by processing conditions. Examples of the processing conditions include a processing condition requiring constant or continuous communication, and a processing condition which does not require constant or continuous communication. In the job data D1 whose processing condition requires constant or continuous communication, the computing device 105 is required to be always communicable during the grid computing processing. In the job data D1 whose processing condition does not require constant or continuous communication, the computing device 105 is not required to be always communicable during the grid computing processing.

### Desired Renewable Energy Rate Information

The desired renewable energy rate information D32 is information indicative of a desired value of the rate of the renewable energy-derived electric power in the electric power consumption used for computation of the job data D1 (desired renewable energy rate value). For example, the desired renewable energy rate information D32 is represented by a percentage of 0% to 100%.

### Job Information

Job information about the job may be stored in the storage 304. The job information includes: job name information indicative of the name of the job; job content information describing the content of the job; job data information about job data corresponding to the job; and job delivery-date information indicative of the delivery date of the job. The Job data information indicates a computation type, a processing condition, a computational amount, etc. of the job data.

### Facility Server

The facility server 40 is owned by a facility. The user visits the facility. The user may make a reservation for visit to the facility. Examples of the facility include an athletic field, a theater, a supermarket, a restaurant, a lodging facility, and a mart or store.

As shown in FIG. 6, the facility server 40 includes an input unit 401, an output unit 402, a communication unit 403, a storage 404, and a controller 405. The configurations of the input unit 401, the output unit 402, the communication unit 403, the storage 404 and the controller 405 of the facility server 40 are similar to those of the input unit 301, the output unit 302, the communication unit 303, the storage 304 and the controller 305 of the client server 30, respectively.

In this embodiment, the storage 404 stores facility information D41 and facility usage information D42.

### Facility Information

The facility information D41 is information about the facility. The facility information D41 includes: a facility ID set for the facility; a facility server ID set for the facility server 40 owned by the facility; facility location information indicative of the location (latitude and longitude) of the facility; and the person-in-charge name, address and telephone number of the facility. The facility ID is one example of facility identification information which identifies the facility. The facility server ID is one example of facility server identification information which identifies the facility server 40.

### Facility Usage Information

The facility usage information D42 indicates a usage status (usage history and usage schedule) of the facility. Specifically, the facility usage information D42 indicates a user who visits the facility and a stay period (or scheduled stay period) in association with each other.

### Management Server

The management server 50 manages the operation of the system 1 in which grid computing is constructed. The management server 50 is owned by a business operator who operates the system 1. The management server 50 is one example of the “management device” in the present invention, and executes the “management method” in the present invention.

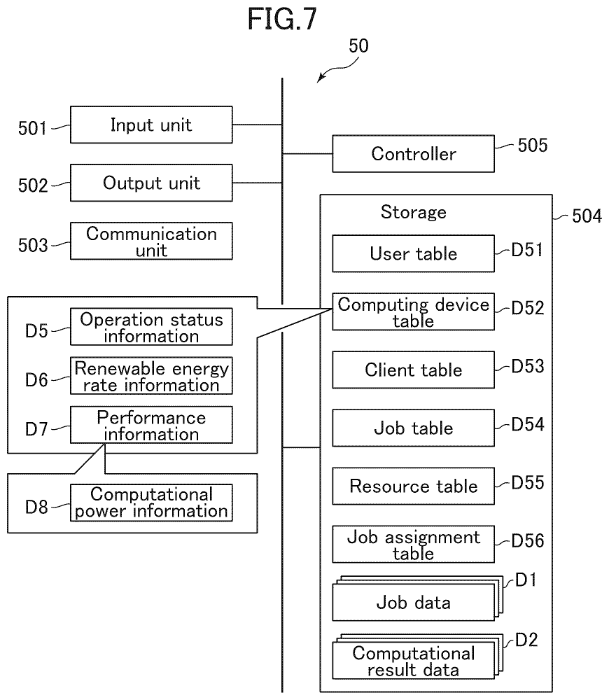

As shown in FIG. 7, the management server 50 comprises an input unit 501, an output unit 502, a communication unit 503, a storage 504, and a controller 505. The configurations of the input unit 501, the output unit 502, the communication unit 503, the storage 504 and the controller 505 of the management server 50 are similar to those of the input unit 301, the output unit 302, the communication unit 303, the storage 304 and the controller 305 of the client server 30, respectively. The storage 504 and the controller 505 are one example of components of the management device for managing the grid computing processing.

In this embodiment, the storage 504 stores a user table D51, a computing device table D52, a client table D53, a job table D54, a resource table D55, a job assignment table D56, job data D1, and computational result data D2.

### User Table

The user table D51 is a table for managing a plurality of users. The user table D51 is configured to, with respect to each user, register therein the user ID set for the user, the vehicle ID set for a vehicle 10 owned by the user, the computing device ID set for a computing device 105 owned by the user, the user terminal ID set for a user terminal 20 owned by the user, etc.

### Computing Device Table

The computing device table D52 is a table for managing a plurality of computing devices 105. The computing device table D52 is configured to, with respect to each computing device 105, register therein the computing device ID set for the computing device 105, the user ID set for a user owning the computing device 105, the vehicle ID set for a vehicle 10 on which the computing device 105 is mounted, etc.

Further, with respect to each computing device 105, the computing device table D52 resisters therein performance (computational power, ratio between CPU and GPU, etc.) of the computing device 105, an operation status (operation history and operation schedule) of the computing device 105, the rate of renewable energy in the amount of electric power fed to the computing device 105, etc. In other words, the computing device table D52 includes: operation status information D5 indicative of the operation status in each of the plurality of computing devices 105; renewable energy rate information D6 indicative of the rate of renewable energy in the amount of electric power fed to each of the plurality of computing devices 105; and performance information D7 indicative of performance of each of the plurality of computing devices 105. The performance information D7 includes computational power information D8 indicative of computational power of each of the plurality of computing devices 105.

### Client Table

The client table D53 is a table for managing a plurality of clients. The client table D53 is configured to, with respect to each client, register therein the client ID set for the client, the client server ID set for a client server 30 owned by the client, the person-in-charge name, address and telephone number of the client, etc.

### Job Table

The job table D54 is a table for managing a plurality of jobs requested from the clients. The job table D54 is configured to, with respect to each job, register therein an acceptance number set for the job, the client ID set for a client requesting for the job, the name and content of the job, etc. The job table D54 is also configured to register therein the computation type and processing condition of job data corresponding to each job, the computational amount required for computation of the job data, the delivery date set for the job, the desired renewable energy rate value of the job data, etc.

### Resource Table

The resource table D55 is a table for managing the computational amount (possible computational amount) by which each computing device is computable during the grid computing processing, and the renewable energy rate of each computing device. Specifically, the resource table D55 is a table for managing the results of the after-mentioned computational resource evaluation processing. With respect to each computing device 105, the resource table D55 registers therein the computing device ID set for the computing device 105, a prediction result of a computational amount by which the computing device 105 is computable during the grid computing processing, the rate of renewable energy in the amount of electric power used when the computing device 105 performs computation in the grid computing processing, etc.

### Job Assignment Table

The job assignment table D56 is a table for managing the results of the after-mentioned job assignment processing. The job assignment table D56 is configured to, with respect to each job, register therein the acceptance number set for the job, job data corresponding to the job, the computing device ID set for a computing device 105 assigned to the job data by the job assignment processing, the rate of renewable energy-derived electric power in the amount of electric power consumption used for computation by all the computing devices 105 assigned to the job data, etc.

### Job Data

The job data D1 stored in the storage 504 is the job data D1 accepted by the after-mentioned job acceptance processing.

### Computational Result Data

The computational result data D2 stored in the storage 504 is job data computed by the after-mentioned grid computing processing, and indicates the result of the computation.

### Update of User Table

Next, update of the user table D51 will be described. The user table D51 is updated by the controller 505 of the management server 50.

For example, when a new user participates in the system 1, the controller 505 updates the user table D51 by registering information regarding the new user in the user table D51.

Specifically, the controller 505 newly sets the user ID to the new user, and registers the “user ID” set for the new user, the “vehicle ID” set in a vehicle 10 owned by the new user, the “computing device ID” set for a computing device 105 mounted on the vehicle 10, and the “user terminal ID” set for a user terminal 20 owned by the new user, in the user table D51 in association with each other.

The “vehicle ID” and the “computing device ID” associated with the new user can be obtained through communication between the vehicle 10 owned by the new user and the management server 50. The “user terminal ID” associated with the new user can also be obtained through communication between the user terminal 20 owned by the new user and the management server 50.

### Update of Computing Device Table

Next, update of the computing device table D52 will be described. The computing device table D52 is updated by the controller 505 of the management server 50.

For example, when a new computing device 105 participates in the system 1, the controller 505 updates the computing device table D52 by registering information regarding the new computing device 105 in the computing device table D52.

Specifically, the controller 505 registers the “computing device ID” set for the new computing device 105, the “user ID” set for a user owning the new computing device 105, the “vehicle ID” set for a vehicle 10 on which the new computing device 105 is mounted, and the “performance”, “operation status” and “renewable energy rate” of the new computing device 105, in the computing device table D52 in association with each other.

The “computing device ID”, “vehicle ID”, “performance”, “operation status” and “renewable energy rate” associated with the new computing device 105 can be obtained through communication between the vehicle 10 on which the new computing device 105 is mounted and the management server 50. The “user ID” associated with the new computing device 105 can also be obtained by referring to the user table D51.

### Periodic Update of Computing Device Table

The “operation status” and the “renewable energy rate” of each computing device 105 registered in the computing device table D52 are periodically updated. In other words, the operation status information D5 and the renewable energy rate information D6 included in the computing device table D52 are periodically updated. This periodic update is performed by the controller 505 of the management server 50.

### First Update Processing

For example, the “operation status” (i.e., operation status information D5) of the computing device 105 in the computing device table D52 may be periodically updated based on the “operation history information D15” of the vehicle 10. Specifically, the controller 505 may execute the following first update processing with respect to each computing device 105 registered in the computing device table D52.

In first update processing, the controller 505 requests the vehicle 10 on which the computing device 105 is mounted, for access to the “operation history information D15”. In response to the request, the computing device 105 of the vehicle 10 permits access to the “operation history information D15”. Based on the operation history of the computing device 105 shown in the operation history information D15, the controller 505 updates the “operation history” which is a past operation status as a part of the “operation status” of the computing device 105, registered in the computing device table D52.

### Second Update Processing

The “operation status” (i.e., operation status information D5) of the computing device 105 in the computing device table D52 may be periodically updated based on the “travel history information D13” of the vehicle 10. Specifically, the controller 505 may execute the following second update processing with respect to each computing devices 105 registered in the computing device table D52.

In second update processing, the controller 505 requests the vehicle 10 on which the computing device 105 is mounted, for access to the “travel history information D13”. In response to the request, the computing device 105 of the vehicle 10 permits access to the “travel history information D13”. Based on the travel history of the vehicle 10 shown in the travel history information D13, the controller 505 estimates the operation history of the computing device 105. Then, based on the estimated operation history of the computing device 105, the controller 505 updates the “operation history” which is a past operation status as a part of the “operation status” of the computing device 105 registered in the computing device table D52.

### Third Update Processing

The “operation status” (i.e. operation status information D5) of the computing device 105 in the computing device table D52 may be periodically updated based on the “schedule information D23” of the user terminal 20. Specifically, the controller 505 may execute the following third update processing with respect to each computing devices 105 registered in the computing device table D52

In third update processing, the controller 505 requests the user terminal 20 owned by a user owning the computing device 105, for access to the “schedule information D23”. In response to the request, the controller 205 of the user terminal 20 permits access to the “schedule information D23”. The controller 505 detects an action status related to the vehicle 10 on which the computing device 105 is mounted, from among action statuses (action histories and action schedules) of the user shown in the schedule information D23.

For example, an action history indicating that the user rode in the vehicle 10 is detected from among action histories which are past action statuses as a part of the action statuses of the user, and an action schedule indicating that the user is scheduled to ride in the vehicle 10 is detected from among action schedules which are future action statuses as the remaining part of the action statuses of the user.

Subsequently, the controller 505 estimates a travel status (travel history and travel schedule) of the vehicle 10 based on the detected action status of the user. Then, based on the estimated travel status of the vehicle 10, the controller 505 estimates the operation status (operation history and operation schedule) of the computing device 105. Then, based on the estimated operation status of the computing device 105, the controller 505 updates the “operation status” of the computing device 105 registered in the computing device table D52.

### Fourth Update Processing

The “operation status” (i.e., operation status information D5) of the computing device 105 in the computing device table D52 may be periodically updated based on the “facility usage information D42” of the facility server 40. Specifically, the controller 505 may execute the following fourth update processing with respect to each computing device 105 registered in the computing device table D52.

In the fourth update processing, the controller 505 requests the facility server 40 for access to the “facility usage information D42”. In response to this request, the facility server 40 permits access to the “facility usage information D42”. The controller 505 detects a usage status related to the vehicle 10 on which the computing device 105 is mounted, from among usage statuses (usage histories and usage schedules) of the facility indicated in the facility usage information D42.

For example, a usage history indicating that a user rode in the vehicle 10 is detected from among usage histories which are past usage statuses as a part of the usage statuses of the facility, and a usage schedule indicating that the user is scheduled to ride in the vehicle 10 is detected from among usage schedules which are future usage statuses as the remaining part of the usage statuses of the facility.

Subsequently, the controller 505 estimates the travel status (travel history and travel schedule) of the vehicle 10 based on the detected usage status of the facility. Then, the controller 505 estimates the operation status (operation history and operation schedule) of the computing device 105 based on the estimated travel status of the vehicle 10. Then, the controller 505 updates the “operation status” of the computing device 105 registered in the computing device table D52 based on the estimated operation status of the computing device 105.

### Fifth Update Processing

The renewable energy rate (i.e., renewable energy rate information D6) of the computing device 105 in the computing device table D52 may be periodically updated based on the “renewable energy management information D16” of the vehicle 10. Specifically, the controller 505 may execute the following fifth update processing with respect to each computing device 105 registered in the computing device table D52.

In the fifth update processing, the controller 505 requests the vehicle 10 on which the computing device 105 is mounted, for access to the “renewable energy management information D16”. In response to this request, the computing device 105 of the vehicle 10 permits access to the “renewable energy management information D16”. The controller 505 updates the “renewable energy rate” of the computing device 105 registered in the computing device table D52, based on the renewable energy rate of the computing device 105 shown in the renewable energy management information D16.

Further, there is a situation where, when the controller 505 requests the vehicle 10 for access to the “renewable energy management information D16”, the vehicle 10 is receiving feeding of electric power from the charging facility 60, and the computing device 105 can perform computation using the electric power fed from the charging facility 60. In such a situation, in response to the request from the controller 505, the computing device 105 of the vehicle 10 transmits, to the controller 505, information indicating that the renewable energy rate is 100% when electric power fed from the charging facility 60 is derived from renewable energy, or information indicating that the renewable energy rate is 0% when electric power fed from the charging facility 60 is not derived from renewable energy, instead of the “renewable energy management information D16”. Based on the information received from the computing device 105 of the vehicle 10, the controller 505 updates the “renewable energy rate” of the computing device 105 registered in the computing device table D52.

### Update of Client Table

Next, update of client table D53 will be described. The client table D53 is updated by the controller 505 of the management server 50.

For example, when a new client participates in the system 1, the controller 505 updates the client table D53 by registering information regarding the new client in the client table D53.

Specifically, the controller 505 newly sets the client ID for the new client, and registers the “client ID” set for the new client, the “client server ID” set for a client server 30 owned by the new client, the “person-in-charge name”, “address” “telephone number” of the new client in the client table D53, in association with each other.

The “client server ID”, “person-in-charge name”, “address” and “telephone number” of the new client can be obtained through communication between the client server 30 and the management server 50.

### Processing (Management Method) by Controller

The controller 505 performs job acceptance processing, computational resource evaluation processing, job assignment processing, grid computing processing, and renewable energy-based feed request processing.

### Job Acceptance Processing (Job Acceptance Step)

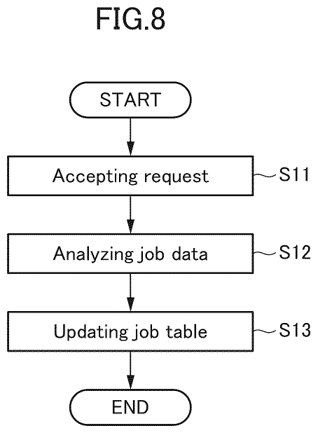

Next, with reference to FIG. 8, job acceptance processing will be described. In the job acceptance processing, the job data D1 requested to be computed by the client is accepted. For example, the controller 505 performs the following processing, every time computation of the job data D1 is requested from the client.

### Step S11

First of all, the management server 50 accepts a request for a job from a client. Specifically, in response to an operation by a person-in-charge of the client of the client, the client server 30 sends a job request application to the management server 50. In response to this application, the controller 505 of the management server 50 performs the following processing.

The controller 505 requests the client server 30 to transmit information required for acceptance of a job (specifically, client information about the client requesting the job, and job information about the job). In this embodiment, the controller 505 transmits image data of a job acceptance screen to the client server 30. The controller 305 of the client server 30 reproduces an image of the job acceptance screen from the image data, and outputs (displays) the image onto the output unit 302 (display part).

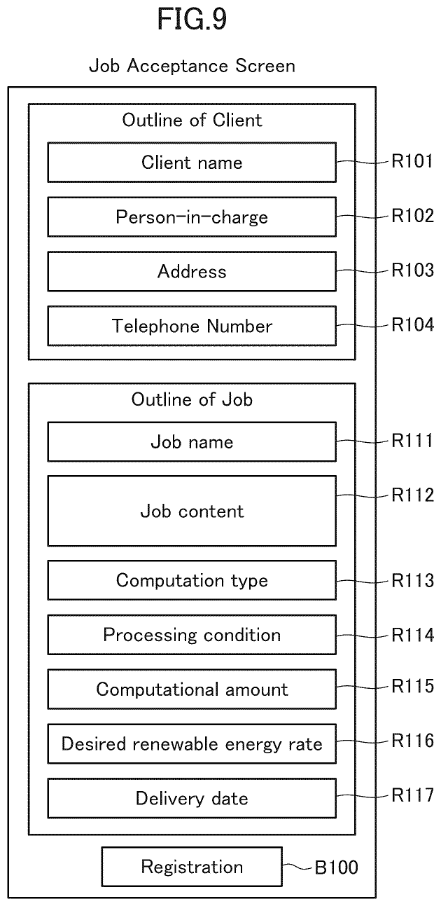

As shown in FIG. 9, the job acceptance screen is a screen for prompting a person-in-charger of the client to input information required for acceptance of the job. The job acceptance screen is provided with: a client name entry field R101 for inputting the name of a client; a person-in-charge name entry field R102 for inputting the name of a person-in-charge of the client; an address entry field R103 for inputting the address of the client; an telephone number entry field R104 for inputting the telephone number of the client; a job name entry field R111 for inputting the name of the job; a job content entry field R112 for inputting an explanation of the content of the job; a computation type entry field R113 for inputting a computation type of the job data corresponding to the job; a processing condition entry field R114 for inputting a processing condition of the job data; a computational amount entry field R115 for inputting the computational amount of the job data; a desired renewable energy rate value entry field R116 for inputting a desired renewable energy rate value of the job; a delivery date entry field R117 for inputting a delivery date of the job; and a registration button B100.

The person-in-charge of the client operates the input unit 301 (manual operation part) of the client server 30 to input information required for the job acceptance screen. Thus, the client information about the client requesting the job, the job information about the job, and the desired renewable energy rate information are input. Then when the input of these information is completed, the person-in-charge of the client operates the input unit 301 (manual operation part) of the client server 30 to press the registration button B100 of the job acceptance screen. When the registration button B100 is depressed, the controller 305 of the client server 30 transmits the information (client information, job information and desired renewable energy rate information) input to the job acceptance screen to the management server 50. The controller 505 of the management server 50 receives the client information, the job information, and the desired renewable energy rate information.

Alternatively, instead of acquiring the information input through the job acceptance screen, the controller 505 may acquire the client information D31, the job information, and the desired renewable energy rate information D32 from the storage 304 of the client server 30. In this case, the controller 305 of the client server 30 transmits the client information D31, the job information and the desired renewable energy rate information D32 to the management server 50, in response to a request from the controller 505 of the management server 50. The controller 505 of the management server 50 receives the client information D31, the job information and the desired renewable energy rate information D32.

Then, the controller 505 requests the client server 30 to transmit the job data D1 corresponding to the job. In response to this request, the controller 305 of the client server 30 transmits the job data D1 corresponding to the job to the management server 50. The controller 505 of the management server 50 receives the job data D1.

### Step S12

Subsequently, the controller 505 of the management server 50 analyzes the job data D1 received in the step S11. Specifically, the controller 505 analyzes the computation type, processing condition, computational amount, etc., of the job data D1. Then, the controller 505 corrects the job information received in the step S11, based on the result of the analysis of the job data D1. If the job information received in the step S11 is sufficiently reliable, the processing in step S12 may be omitted.

### Step S13

Subsequently, the controller 505 of the management server 50 associates the client information and the desired renewable energy rate information received in the step S11 with the job information corrected as needed in the step S12 (or the job information received in the step S11), and registers them in the job table D54. Further, the controller 505 stores the job data D1 received in the step S11, in the storage 504.

### [Computational Resource Evaluation Processing (Computational Resource Evaluation Step)]

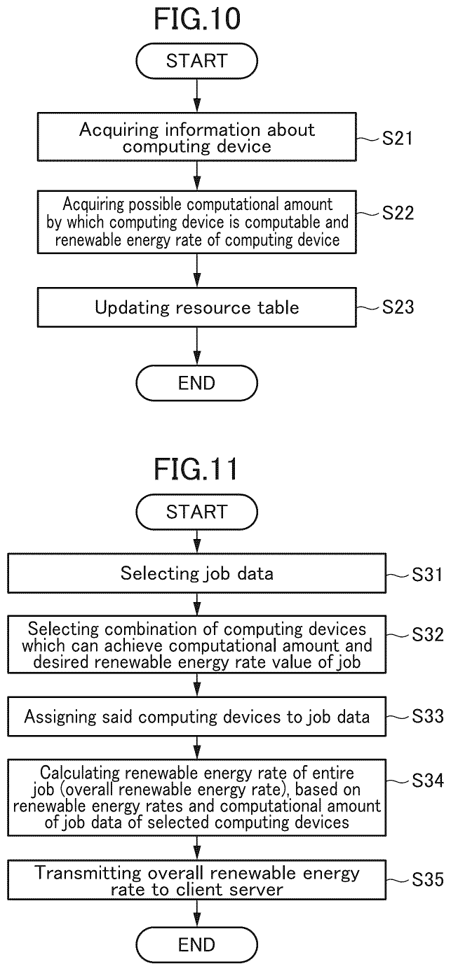

Next, with reference to FIG. 10, computational resource evaluation processing will be described. In the computational resource evaluation processing, the computing device 105 predicts, based on the computing device table D52 (specifically, the computational power information D8 and the operation status information D5) stored in the storage 504, a computational amount by which the computing device 105 is computable among the plurality of computing devices 105 during the grid computing processing, and acquires the renewable energy rate of the computing device 105. For example, when the computing device table D52 (specifically, at least one of the computational power information D8, the operation status information D5 and the renewable energy rate information D6) stored in the storage 504 is updated, the controller 505 performs the following processing.

### Step S21

First of all, the controller 505 acquires the “computational power”, the “operation status”, and the “renewable energy rate” of the computing device 105 registered in the computing device table D52. In other words, the controller 505 acquires the computational power information D8, the operation status information D5, and the renewable energy rate information D6 included in the computing device table D52.

### Step S22

Subsequently, with respect to each computing device 105, the controller 505 predicts a computational amount by which the computing device 105 is computable during the grid computing processing, based on the computational power of the computing device 105 shown in the computational power information D8, and the operation status of the computing device 105 shown in the operation status information D5. Further, with respect to each computing device 105, the controller 505 acquires a renewable energy rate of the computing device 105 during the grid computing processing, based on the renewable energy rate information D6.

For example, from the operation status of the computing device 105 shown in the operation status information D5, the controller 505 predicts a tendency (pattern) of a change in usage rate of the computational power of the computing device 105. The prediction of the tendency of the change in usage rate of the computational power of the computing device 105 may be realized by machine learning. Then, based on the tendency of the change in usage rate of the computational power of the computing device 105, the controller 505 predicts a period (time period) during which the computational power of the computing device 105 has a margin (period during which the usage rate of the computational power is not 100%), and defines such a period as “a period during which the computational power of the computing device 105 can be used for the grid computing processing”. For example, the controller 505 defines a period during which the usage rate of the computational power of the computing device 105 is “30%”, as a period during which “70%” of the computational power of the computing device 105 can be used during the grid computing processing. Then, based on a temporal change in the predicted computational power of the computing device 105 usable during the grid computing processing, the controller 505 predicts a computational amount by which the computing device 105 is computable for a given period (e.g., one day) from the present time (possible computational amount of the computing device 105). For example, the unit of this possible computational amount is the number of code blocks of a program constituting the job.

Further, from the renewable energy rate of the computing device 105 shown in the renewable energy rate information D6, the controller 505 acquires the rate of renewable energy in electric power used when the computing device 105 performs computation during the grid computing processing.

### Step S23

Subsequently, with respect to each computing device 105, the controller 505 registers, in the resource table D55, the computational amount by which the computing device 105 is computable during the grid computing processing, which has been predicted in the step S22, and the rate of renewable energy in electric power used by the computing device 105 during the grid computing processing, which has been acquired in the step S22. In this way, the resource table D55 is updated.

### [Job Assignment Processing (Job Assignment Step)]

Next, with reference to FIG. 11, the job assignment processing will be described. The job assignment processing is configured to, based on the result of the computational resource evaluation processing, assign any computing device 105 usable in the grid computing processing among the plurality of computing devices 105 to the job data D1 accepted in the acceptance processing. For example, after completion of the job acceptance processing, the controller 505 performs the following processing

### Step S31

First of all, the controller 505 selects a job as the subject of the job assignment processing from among jobs registered in the job table D54. For example, the controller 505 selects a job whose delivery date is the earliest among the jobs registered in the job table D54. Then, the controller 505 selects job data D1 corresponding to the job as the subject of the job assignment processing, from among plural pieces of job data D1 stored in the storage 504.

### Step S32

Subsequently, based on the prediction results of the computational amounts and the renewable energy rates of the plurality of computing devices 105, registered in the resource table D55, the controller 505 selects, from among the plurality of computing devices 105, a combination of computing devices 105 which can achieve the computational amount and the desired renewable energy rate value required in the grid computing processing for the job data D1 selected in the step S31.

Specifically, the controller 505 refers to the job table D54 to acquire a computational amount required for computation of the job data D1 and a desired renewable energy rate value of the job data D1. Then, the controller 505 refers to the resource table D55 to acquire respective possible computational amounts and renewable energy rates of the plurality of computing devices 105, and determine a combination of computing devices 105 which can achieve the computational amount and the desired renewable energy rate value of the job data D1. For example, assume that: the computational amount required for the computation of the job data D1 is 100 code blocks; the desired renewable energy rate value of the job data D1 is 50%; the resource table D55 registers therein six computing devices 105 (a computing device A [possible computational amount: 20 code blocks, renewable energy rate: 50%], a computing device B [possible computational amount: 50 code blocks, renewable energy rate: 100%], a computing device C [possible computational amount: 30 code blocks, renewable energy rate: 50%], a computing device D [possible computational amount: 30 code blocks, renewable energy rate: 0%], a computing device E [possible computational amount: 50 code blocks, renewable energy rate: 100%], and a computing device F [possible computational amount: 20 code blocks, renewable energy rate: 70%]). In this case, when the computing device A, the computing device C, and the computing device E are selected, the total possible computational amount can be calculated as 20+30+50=100, and a weighted average value of the renewable energy rates of the selected computing devices calculated by weighting the renewable energy rate by the possible computational amount of each of the computing device 105 can be calculated as (20×50%+30×50%+50×100%)/(20+30+50)=75%. That is, it is understandable that both the computational amount required for the computation of the job data D1 and the desired renewable energy rate value of the job data D1 can be achieved by selecting the computing device A, the computing device C, and the computing device E. Therefore, the controller 505 selects a combination of the computing devices A, C and E from among the six computing devices 105 registered in the resource table D55 Alternatively, from among the computing devices 105 each of whose renewable energy rate exceeds the desired renewable energy rate value of the job data D1, two or more computing device 105 may be selected such that the total value of the possible computational amounts thereof is equal to or greater than the computational amount of the job data D1 (for example, the computing devices B and E may be selected).

### Step S33

Subsequently, the controller 505 assigns the computing devices 105 selected in the step S32 to the job data D1 selected in the step S31. Then, the controller 505 registers, in the job assignment table D56, job assignment result information indicative of which computing device 105 is assigned to which job data D1.

### Step S34

Subsequently, the controller 505 calculates, based on the renewable energy rates of the selected computing devices 105 and the computational amount of the job data D1, an overall renewable energy rate indicative of the rate of renewable energy in electric power consumption used for computation of the job data D1 by all the computing devices 105 assigned to the job data D1. Specifically, the controller 505 calculates a weighted average value of the renewable energy rates of the selected computing devices 105 by weighting the renewable energy rate by the possible computational amount of each of the selected computing devices 105, and sets the weighted average value as the overall renewable energy rate. For example, when the computing device A, the computing device C and the computing device E are selected as described above, the overall renewable energy rate of the job data D1 is calculated as (20×50%+30×50%+50×100%)/(20+30+50)=75%.

### Step S35

Subsequently, the controller 505 transmits overall renewable energy rate information representing the overall renewable energy rate calculated in the Step S35, to the client server 30 of the client who requested the computation of the job data D1 selected in the Step S31.

### [Grid Computing Processing]

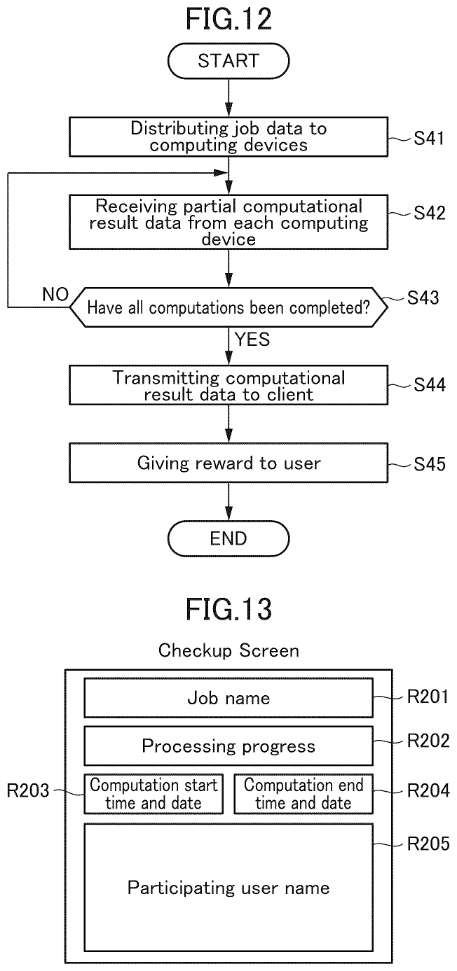

Next, with reference to FIG. 12, the grid computing processing will be described. In the grid computing processing, the job data D1 is processed by the computing devices 105 assigned to the job data D1 in the job assignment processing. For example, after completion of the job assignment processing, the controller 505 performs the following processing.

### Step S41

First of all, the controller 505 refers to the job assignment table D56 to distribute the job data D1 as the subject of the grid computing processing to the computing devices 105 assigned to the job data D1 in the job assignment processing. Specifically, the controller 505 transmits parts of the job data D1 to the computing devices 105 assigned to the job data D1, respectively. At this time, the controller 505 distributes the job data D1 such that a computational amount of each part of the job data D1 to be computed by each of the computing devices 105 does not exceed the possible computational amount of said each of the computing devices 105. Thus, the job data D1 is processed in parallel by the computing devices 105 assigned to the job data D1.

### Step S42

Subsequently, when the computation of data (part of the job data D1) transmitted to the each of the computing devices 105 is completed, each of the computing devices 105 transmits partial computational result data obtained by the computation, to the management server 50. The controller 505 of the management server 50 receives the partial computational result data transmitted from each of the computing devices 105, and stores the partial computational result data in the storage 504.

### Step S43

The controller 505 determines whether all of the computing devices 105 to which the job data D1 is distributed in the step S41 have completed their computations. When all the computing devices 105 have completed the computations (step S43: YES), processing of step S44 is performed. On the other hand, if not (step S43: NO), the processing of the step S42 is performed.

### Step S44

When all the computing devices 105 have completed the computations, the controller 505 combines the plural pieces of partial computational result data stored in the storage 504 to generate computational result data D2 corresponding to the job data D1 as the subject of the grid computing processing (computational result data D2 indicative of the result of computation of the job data D1). Then, the controller 505 transmits the computational result data D2 corresponding to the job data D1 as the subject of the grid computing processing, to the client server 30 of the client requesting the computation of the job data D1.

### Step S45

Subsequently, a reward is given from the business operator who operates the system 1 to a user who provided the computational power of his/her computing device 105 to the grid computing processing. Examples of the reward to be given to the user include points usable in the system 1, a virtual currency (cryptocurrency), and discount privilege of goods. For example, the controller 505 of the management server 50 performs processing for giving a reward to the user who provided the computational power of the computing device 105 to the grid computing processing. Examples of the processing for giving a reward include processing of associating the “user ID” set to the user with a “point” (or virtual currency) usable in the system 1, and registering them in the user table D51, and processing of transmitting information indicative of a discount privilege of goods, to the user terminal 20 owned by the user. The information indicative of the reward may be registered in the job table D54 with respect to each job.

Alternatively or additionally, a reward may be given from the client to a user who provided the computational power of his/her computing device 105 to the grid computing processing. For example, the controller 305 of the client server 30 may perform processing for giving a reward to a user who provided the computational power of his/her computing device 105 to the grid computing processing.

### [Job Progress Checkup]

In this embodiment, when the controller 505 of the management server 50 receives a request for checkup of the processing progress of a job, from the client server 30 of the client who requests the job, the controller 505 transmits, in response to the request, image data of a checkup screen for checking up the processing progress of the job to the client server 30. The client server 30 reproduces an image of the checkup screen from the image data, and outputs (displays) the image to the output unit 302 (display part)

As shown in FIG. 13, the checkup screen is provided with: a job name display field R201 for displaying the name of a job; a processing progress display field R202 for displaying the processing progress of the job; a computation start time and date display field R203 for displaying the time and date when processing of the job is started; a computation end time and date display field R204 for displaying the time and date when the processing of the job is ended; and a participating user display field R205 for displaying the name of a user providing the computational power of the computing device 105 to the grid computing processing for the job.

### [Renewable Energy-Based Feed Request Processing (Renewable Energy-Based Feed Request Step)]

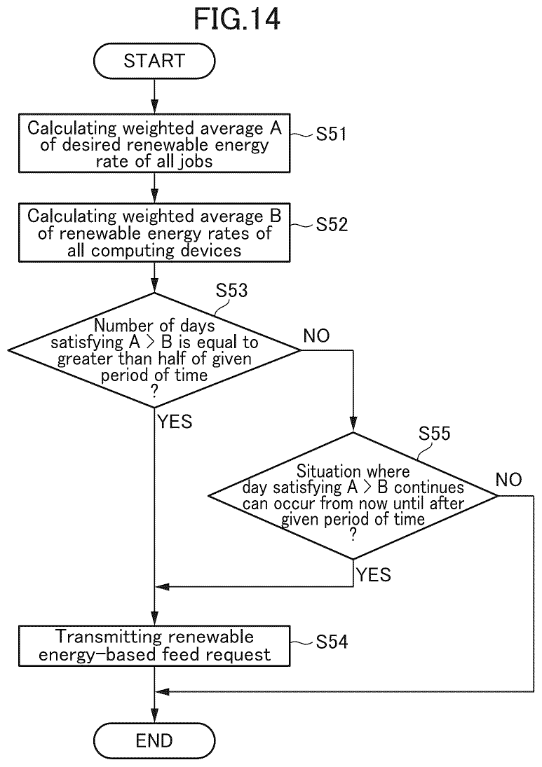

Next, with reference to FIG. 14, renewable energy-based feed request processing will be described. The renewable energy-based feed request processing is a process of transmitting, to the computing device 105, renewable energy-based feed request information for prompting the user to perform electric power feeding to the vehicle 10 by renewable energy-derived electric power, when a weighted average of the renewable energy rates of all a plurality of computing devices 105 is less than a weighted average of desired renewable energy rate values of all plural pieces of job data D1. For example, the controller 505 performs the following processing at a predetermined clock time every day.

### Step S51

First of all, the controller 505 refers to the job table D54 to acquire the computational amount required for computation of each of plural pieces of job data D1 and the desired renewable energy rate value of the job data D1 of said each of the plural pieces of job data D1. Then, the controller 505 calculates a weighted average A of desired renewable energy rate values of the plural pieces of job data D1 by weighting the desired renewable energy rate value by the computational amount of each of the plural pieces of job data D1. For example, the job table D54 registers therein: a first job “molecular structure analysis of new material development” (desired renewable energy rate value: 100%, computational amount: 50 code blocks); a second job “city activity amount simulation” (desired renewable energy rate value: 50%, computational amount: 100 code block); and a third job “artificial satellite orbit computation” (desired renewable energy rate value: 0%, computational amount: 30 code blocks). In this case, the weighted average A of the desired renewable energy rate values of all the three pieces of job data D1 is calculated as (50×100%+100×50%+30×0%)/(50+100+30)=56%.

### Step S52

Subsequently, the controller 505 refers to the resource table D55 to acquire the possible computational amount and the renewable energy rate of each of a plurality of computing devices 105. Then, the controller 505 calculates a weighted average B of the renewable energy rates of all the computing devices 105 by weighting the renewable energy rate by the computational amount of each of the computing devices 105. For example, assume that the resource table D55 registers therein six computing devices 105 (a computing device A [computational amount: 20 code blocks, renewable energy rate: 50%], a computing device B [computational amount: 50 code blocks, renewable energy rate: 100%], a computing device C [computational amount: 30 code blocks, renewable energy rate: 50%], a computing device D [computational amount: 30 code blocks, renewable energy rate: 0%], a computing device E [computational amount: 50 code blocks, renewable energy rate: 100%], and a computing device F [computational amount: 20 code blocks, renewable energy rate: 70%]). In this case, the weighted average B of the renewable energy rates of all the six computing devices 105 is calculated as (20×50%+50×100%+30×50%+30×0%+50×100%+20×70%)/(20+50+30+30+50+20)=70%.

### Step S53

Subsequently, the controller 505 refers to computational results of the weighted average A of the desired renewable energy rate values of all plural pieces of job data in the latest given period (e.g., seven days), and the weighted average B of the renewable energy rates of all the computing devices 105, to determine whether or not the number of days satisfying the following relation: “the weighted average A of the desired renewable energy rate values of all the plural pieces of job data>the weighted average B of the renewable energy rates of all the computing devices 105” (i.e. a condition that the renewable energy rate of the computing device 105 is less than the desired renewable energy rate value of the job data), is equal to or greater than half of the given period.

### Step S54

As a result of the determination in the step S53, when the number of days satisfying the following relation: “the weighted average A of the desired renewable energy rate values of all the plural pieces of job data>the weighted average B of the renewable energy rates of all the computing devices 105”, is equal to or greater than half of the given period (Step S53: YES), the controller 505 transmits, to at least part of the computing devices 105, the renewable energy-based feed request information for prompting performing electric power feeding to the vehicles 10 by renewable energy-derived electric power (Step S53: YES). The transmission of the renewable energy-based feed request information is not carried out every time the processing of the steps S51 to S53 is performed, but is carried out every certain period (e.g. every week). This is because the user may be annoyed if the renewable energy-based feed request information is repeatedly notified in a short period.

When transmitting the renewable energy-based feed request information to at least part of the computing devices 105, for example, the controller 505 selects, from among the plurality of computing devices 105, one or more computing devices 105 whose computational time for the grid computing processing within the aforementioned given period is relatively long and whose renewable energy rate is relatively low, and transmits the renewable energy-based feed request information. Alternatively, the controller 505 may transmit the renewable energy-based feed request information to all the computing devices 105. For example, the renewable energy-based feed request information includes location information, priority use right, discount coupon for charging fee, etc. of the charging facility 60 using renewable energy-derived electric power. Further, when electric power feeding to the vehicle 10 is performed by renewable energy-derived electric power, or when computation of the job data is carried out while receiving electric power feeding from the charging facility 60 using renewable energy-derived electric power, information indicating that a bonus (e.g., n-times the normal points) is given as the computation's reward may be included in the renewable energy-based feed request information. Examples of processing for giving such a bonus include processing of associating the “user ID” set for the user with a bonus to be given when performing the next computation, and registering them in the user table D51.

### Step S55

As a result of the determination in the step S53, when the number of days satisfying the following relation: “the weighted average A of the desired renewable energy rate values of all the plural pieces of job data>the weighted average B of the renewable energy rates of all the computing devices 105”, is less than half of the given period (Step S53: NO), the controller 505 determines whether or not it is predicted that a situation where the day satisfying the following relation: “the weighted average A of the desired renewable energy rate values of all the plural pieces of job data>the weighted average B of the renewable energy rates of all the computing devices 105”, continues for two or more days, occurs from now until after a given period (e.g., one month). For example, the controller 505 performs a time-series regression analysis for each of the weighted average A of the desired renewable energy rate values of all the plural pieces of job data and the weighted average B of the renewable energy rates of all the computing devices 105, and when the weighted average B of the renewable energy rates of all the computing devices 105 is less than the weighted average A of the desired renewable energy rate values of all the plural pieces of job data, from now until after given period, the controller 505 determines that the situation where the day satisfying the following relation: “the weighted average A of the desired renewable energy rate values of all the plural pieces of job data>the weighted average B of the renewable energy rates of all the computing devices 105”, continues for two or more days, is predicted (Step S55: YES).

As a result of the determination in the step S55, when it is predicted that the situation where the day satisfying the following relation: “the weighted average A of the desired renewable energy rate values of all the plural pieces of job data>the weighted average B of the renewable energy rates of all the computing devices 105”, continues for two or more days, occurs from now until after the given period (Step S55: YES), the controller 505 executes the processing of the step S54. On the other hand, if not (Step S55: NO), the controller 505 terminates the renewable energy-based feed request processing without executing the processing of the step S54.

While the present invention have been described based on one embodiment thereof, specific configurations and means of the present invention may be arbitrarily altered and modified within the spirit and scope of the technical ideas of the claimed inventions. Such a modification will now be described.

First, the technical problem to be solved by the invention and the effects of the invention are not limited to the aforementioned content. Specifically, the present invention can solve technical problems which are not described in the above and provide effects which are not described in the above, or can solve only part of the described technical problems and provide only part of the described effects.

In the above embodiment, in the renewable energy-based feed request processing, as the result of the determination in the step S53, when the number of days satisfying the following relation: “the weighted average A of the desired renewable energy rate values of all the plural pieces of job data>the weighted average B of the renewable energy rates of all the computing devices 105” is less than half of the given period (Step S53: NO), the processing of the step S55 is performed. Alternatively, the renewable energy-based feed request processing may be terminated without performing the processing of the step S55. Alternatively, processing in the step S53 may be omitted, and the processing in the step S55 may be performed after the processing in the step S52.

Further, in the step S54 of the renewable energy-based feed request processing, the transmission of the renewable energy-based feed request information is not performed every time the processing in the steps S51-S53 is performed, but is executed every certain period. Alternatively, it may be performed every time the processing in the steps S51-S53 is performed.

### [Operation/Function and Effect]

Last of all, the operations/functions and effects of the management servers 50 according to the present embodiment and the modification of the present embodiment will be described.

In the above embodiment, the controller 505 of the management server 50 acquires, based on the computational amount of the job data D1 to be processed by the computing devices 105 and the renewable energy rate information, the overall renewable energy rate information indicative of the rate of the amount of renewable energy-derived electric power in the amount of electric power consumption used for computation of the job data D1 by all the computing devices 105 assigned to the job data D1, and transmits the overall renewable energy rate information to the client server 30. This makes it possible to inform an operator of the client server 30 which provided the job data D1 of the rate of renewable energy in electric power used during the grid computing processing, thereby supporting the utilization of renewable energy by the operator 30 of the client server which requested for the grid computing processing.

Further, in the above embodiment, a weighted average obtained by weighting the rate of the amount of renewable energy-derived electric power in the amount of electric power fed to each of the computing devices 105 assigned to the job data D1, by the passible computational amount of said each of the computing devices 105 is used as the overall renewable energy rate information. Thus, the controller 505 can inform the operator of the client server 30 of the renewable energy rate obtained by taking into consideration the computational amount required for computation of the job data, and the possible computational amount in each of the computing devices, thereby supporting the operator of the client server 30 to adequately figure out a renewable energy usage status in the grid computing processing.

### LIST OF REFERENCE SIGNS

1: system
10: vehicle
105: computing device
106: battery
20: user terminal
30: client server
40: facility server
50: management server
501: input unit
502: output unit
503: communication unit
504: storage
505: controller
60: charging facility
D1: job data
D2: computational result data
D6: renewable energy rate information
D16: renewable energy management information
D32: desired renewable energy rate information

1. A management device for managing grid computing processing of causing computing devices mounted respectively on a plurality of vehicles to process job data provided from a client server, the management device comprising:
a storage; and
a controller, wherein:
the storage is configured to store renewable energy rate information indicative of a rate of an amount of renewable energy-derived electric power in an amount of electric power fed to each of the computing devices; and
the controller is configured to perform:
job acceptance processing of accepting the job data from the client server;
job assignment processing of selecting one or more of the computing devices, and assigning the selected one or more computing devices to the job data;
the grid computing processing of distributing the job data to respective ones of the one or more computing devices assigned to the job data, receiving computational result data of the distributed job data from each of the one or more computing devices, and transmitting the received computational result data to the client server; and
overall renewable energy rate provision processing of acquiring overall renewable energy rate information indicative of a rate of an amount of renewable energy-derived electric power in an amount of electric power consumption used for computation of the job data by all the one or more computing devices assigned to the job data, based on a computational amount of the distributed job data to be processed by each of the one or more computing devices, and the renewable energy rate information of said each of the one or more computing devices, and transmitting the overall renewable energy rate information to the client server.

2. The management device as claimed in claim 1, wherein
the storage is configured to store a possible computational amount by which each of the computing devices is computable in the grid computing processing, and
the controller is configured to use, in the overall renewable energy rate provision processing, as the overall renewable energy rate information, a weighted average obtained by weighting a rate of an amount of renewable energy-derived electric power in an amount of electric power fed to each of the one or more computing devices assigned to the job data by the possible computational amount of said each of the one or more computing devices.

3. A management method for managing, by a computer, grid computing processing of causing computing devices mounted respectively on a plurality of vehicles to process job data provided from a client server, the management method comprising:
a storage step of storing renewable energy rate information indicative of a rate of an amount of renewable energy-derived electric power in an amount of electric power fed to each of the computing devices;
a job acceptance step of accepting the job data from the client server;
a job assignment step of selecting one or more of the computing devices, and assigning the selected one or more computing devices to the job data;
a grid computing step of distributing the job data to respective ones of the one or more computing devices assigned to the job data, receiving computational result data of the distributed job data from each of the one or more computing devices, and transmitting the received computational result data to the client server; and
an overall renewable energy rate provision step of acquiring overall renewable energy rate information indicative of a rate of an amount of renewable energy-derived electric power in an amount of electric power consumption used for computation of the job data by all the one or more computing devices assigned to the job data, based on a computational amount of the distributed job data to be processed by each of the one or more computing devices, and the renewable energy rate information of said each of the one or more computing devices, and transmitting the overall renewable energy rate information to the client server.
